(19) United States
(12) Patent Application Publication
(10) Pub. No.: US 2008/0171232 A1
(43) Pub. Date: Jul. 17, 2008

(54) Magnetic head and method of producing the same

(75) Inventors: Tomoka Aoki, Kawasaki (JP); Junichi Hashimoto, Kawasaki (JP); Mitsuru Otagiri, Kawasaki (JP); Hideyuki Akimoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/977,205

(22) Filed: Oct. 24, 2007

(30) Foreign Application Priority Data
Jan. 12, 2007 (JP) 2007-4793

(51) Int. Cl. G11B 5/39; C25D 5/10

(52) U.S. Cl. 428/811.2; 205/170

(57) ABSTRACT

In the magnetic head, a lower shielding layer and an upper shielding layer of a read-head and a lower magnetic pole of a write-head are electrically connected to a substrate so as to prevent damage of an MR element caused by static electricity and so as not to badly influence reading characteristics of a read-head. The magnetic head comprises: a read-head having a lower shielding layer and an upper shielding layer, which are electrically connected to a substrate via a shunt resistance; and a write-head having a lower magnetic pole, which is electrically connected to the substrate via the shunt resistance, wherein the lower shielding layer and the upper shielding layer are electrically connected to the substrate via a conductive layer, and the lower magnetic pole is electrically connected to the substrate via a conductive layer, which is formed as a base layer of the lower magnetic pole.

### BACKGROUND OF THE INVENTION

The present invention relates to a magnetic head and a method of producing the magnetic head, more precisely relates to a magnetic head, whose MR element is not damaged by static electricity, and a method of producing the magnetic head.

FIG. 16 is a sectional view of a magnetic head, which includes a CIP type G-MR (Giant Magneto Resistance) element 5, taken along a line perpendicular to an air bearing surface. The magnetic head is formed by layering a read-head 10 and a write-head 20 on a substrate 2 made of ALTIC (Al₂O₃—TiC). The read-head 10 comprises a lower shielding layer 4, an upper shielding layer 6 and the MR-element 5 provided between the shielding layers 4 and 6; the write-head 20 comprises a lower magnetic pole 12, an upper magnetic pole 14, a write-gap formed between the magnetic poles 12 and 14 and, an exciting coil 16.

When the magnetic head contacts a recording medium, the lower shielding layer 4 and the upper shielding layer 6 are sometimes electrically charged. The MR element 5 has low resistance to static electricity, so damage of the MR element 5 caused by static electricity must be avoided. Thus, the lower shielding layer 4 and the upper shielding layer 6 are electrically connected to the substrate 2 via a shunt resistance 3 so as to prevent the shielding layers 4 and 6 from electrostatic charge.

In the magnetic head shown in FIG. 16, plating seed layers 41 and 61, which are respectively used for forming the lower shielding layer 4 and the upper shielding layer 6 by electrolytic plating, are connected to a conductive section 4a, so that the lower shielding layer 4 and the upper shielding layer 6 can be electrically connected to the substrate 2 via a shunt resistance 3.

Note that, the lower magnetic pole 12 of the write-head 20 is also electrically connected to the substrate 2 so as to prevent electrostatic charge. In the magnetic head shown in FIG. 16, the lower magnetic pole 12 has a projection 12a, which slightly bites the upper shielding layer 6, so as to electrically connect the lower magnetic pole 12 to the upper shielding layer 6. With this structure, the lower magnetic pole 12 can be electrically connected to the substrate 2.

In a CPP type magnetic head including, for example, T-MR element, a lower shielding layer and an upper shielding layer act as electrodes of a read-head. Therefore, the lower shielding layer and the upper shielding layer are separately electrically connected to a substrate via shunt resistances. To electrically connect a lower magnetic pole to the substrate, the magnetic pole is electrically connected to the substrate via a different shunt resistance.

Japanese Patent Gazette No. 2003-85710 discloses a magnetic head, in which an upper shielding layer and a lower magnetic pole are electrically connected via a conductive layer so as to prevent the upper shielding layer and a lower shielding layer from corrosion.

FIG. 17 is a plan view of the magnetic head shown in FIG. 16, wherein the lower magnetic pole 12, the upper shielding layer 6 and the plating seed layer 61 are seen from the upper side. Planar shapes of the lower magnetic pole 12, the upper shielding layer 6 and the lower shielding layer 4 are rectangular shapes. The plating seed layer 61 also has a rectangular planar shape and is outwardly extended from an edge of the upper shielding layer 6.

The projection 12a of the lower magnetic pole 12, which faces the upper shielding layer 6, is elongated in a width direction of the upper shielding layer 6 and fitted in a concave section formed in an upper face of the upper shielding layer 6. A conductive section 4a is connected to an extended end part of the plating seed layer 61 at a center in the width direction thereof.

In case that the projection 12a of the lower magnetic pole 12 bites the upper shielding layer 6, as describe above, so as to connect the lower magnetic pole 12 to the upper shielding layer 6, a magnetic field of the write head 20, which is used for writing data, influences a magnetic domain structure of the upper shielding layer 6 and reading characteristics of the magnetic head will be varied. The lower shielding layer 4 and the upper shielding layer 6 shield the MR element from undesirable external magnetic fields. If the magnetic domain structure of the upper shielding layer 6 is varied, read-noises will be generated.

### SUMMARY OF THE INVENTION

The present invention was conceived to solve the above described problems.

An object of the present invention is to provide a magnetic head, in which a lower shielding layer and an upper shielding layer of a read-head and a lower magnetic pole of a write-head are electrically connected to a substrate so as to prevent damage of an MR element caused by static electricity and so as not to badly influence reading characteristics of a read-head.

To achieve the object, the present invention has following structures.

Namely, the magnetic head of the present invention comprises: a read-head having a lower shielding layer and an upper shielding layer, which are electrically connected to a substrate via a shunt resistance; and a write-head having a lower magnetic pole, which is electrically connected to the substrate via the shunt resistance, wherein the lower shielding layer and the upper shielding layer are electrically connected to the substrate via a conductive layer, and the lower magnetic pole is electrically connected to the substrate via a conductive layer, which is formed as a base layer of the lower magnetic pole.

In case of constituting a shunt structure with the conductive layer, the shunt resistance may be separately formed from the conductive layer. Further, resistance of the conductive layer may be used as the shunt resistance. Note that, the present invention can be applied to a CIP type magnetic head and a CPP type magnetic head.

In the magnetic head, a plating seed layer of the lower magnetic pole may be used as the conductive layer of the lower magnetic pole. With this structure, the lower magnetic pole can be easily and securely electrically connected to the substrate when the lower magnetic pole is formed by plating.

In the magnetic head, the lower shielding layer may be connected to the shunt resistance via a conductive section, and the lower magnetic pole may be connected to the shunt resistance via an upper conductive section.

Preferably, an upper face of the upper shielding layer and an upper face of the upper conductive section are included in the same plane. With this structure, the upper shielding layer can be securely electrically separated from the lower magnetic pole.

In the magnetic head, the conductive layer of the lower magnetic pole may be extended beyond an outer edge of the lower magnetic pole, and the lower magnetic pole is electrically connected to the substrate via the conductive layer. With this structure, wires for connecting the conductive layer to the substrate can be easily arranged.

In the magnetic head, a planar shape of the conductive layer may be designed to shield a wire area, in which a wire connected to the read-head are provided, from another wire area, which overlaps the wire area and in which a wire connected to the write-head is provided. With this structure, electric interference between the read-head and the write-head can be restrained, and characteristics of the magnetic head can be improved.

The method of producing a magnetic head comprises:

a step of forming a lower shielding layer, a conductive section, to which one end of a shunt resistance will be connected, and a substrate conductive section, to which the other end of the shunt resistance will be connected, on a substrate by electrolytic plating, in which a plating seed layer is used as a power feed layer; a step of forming an MR element and the shunt resistance, which are connected to the conductive section and the substrate conductive section, in a layer above the lower shielding layer; a step of forming a plating seed layer on the layer including the MR element and the shunt resistance, forming an upper shielding layer, which is connected to the conductive section, by electrolytic plating, in which the plating seed layer is used as a power feed layer, and forming an upper conductive section connected to the conductive section; and a step of forming a plating seed layer, which is connected to the upper conductive section, on the upper shielding layer, and a lower magnetic pole by electrolytic plating, in which the plating seed layer is used as a power feed layer.

A head slider of the present invention comprises: a magnetic head including a write-head and a read-head, wherein the read-head has a lower shielding layer and an upper shielding layer, which are electrically connected to a substrate via a shunt resistance, the write-head has a lower magnetic pole, which is electrically connected to the substrate via the shunt resistance, the lower shielding layer and the upper shielding layer are electrically connected to the substrate via a conductive layer, and the lower magnetic pole is electrically connected to the substrate via a conductive layer, which is formed as a base layer of the lower magnetic pole.

In the head slider, a plating seed layer of the lower magnetic pole may be used as the conductive layer of the lower magnetic pole.

Further, a magnetic disk apparatus of the present invention comprises: a head slider including a magnetic head, which writes data on and reads data from a magnetic recording medium by a write-head and a read-head, wherein the read-head has a lower shielding layer and an upper shielding layer, which are electrically connected to a substrate via a shunt resistance, the write-head has a lower magnetic pole, which is electrically connected to the substrate via the shunt resistance, the lower shielding layer and the upper shielding layer are electrically connected to the substrate via a conductive layer, and the lower magnetic pole is electrically connected to the substrate via a conductive layer, which is formed as a base layer of the lower magnetic pole.

In the magnetic head of the present invention, the lower magnetic pole of the write-head is separated from the upper shielding layer of the read-head, the shunt structure including the lower shielding layer and the upper shielding layer of the read-head is constituted, and the shunt structure including the lower magnetic pole of the write-head is constituted. Therefore, the read-head and the write-head do not interfere each other, so that the magnetic head can improve magnetic characteristics and resistance to static electricity. In the production method of the present invention, the magnetic head having superior reading characteristics and superior resistance to static electricity can be produced without significantly changing the conventional production method.

### BRIEF DESCRIPTION OF THE DRAWINGS

Embodiments of the present invention will now be described by way of examples and with reference to the accompanying drawings, in which:

FIG. 1 is a sectional view of a magnetic head of a first embodiment of the present invention;

FIG. 2 is a plan view of the magnetic head of the first embodiment;

FIG. 3 is a sectional view of a magnetic head of a second embodiment of the present invention;

FIG. 4 is a plan view of the magnetic head of the second embodiment;

FIGS. 5A-5F are explanation views showing a process of producing the magnetic head;

FIGS. 6A-6E are explanation views showing the process of producing the magnetic head;

FIGS. 7A-7E are explanation views showing the process of producing the magnetic head;

FIGS. 8A and 8B are explanation views showing the process of producing the magnetic head;

FIGS. 9A-9E are explanation views showing another process of producing the magnetic head;

FIG. 10 is a plan view of a shunt structure of a conventional CPP type magnetic head;

FIG. 11 is a plan view of a shunt structure of another conventional CPP type magnetic head;

FIG. 12 is a plan view of a shunt structure of the CPP type magnetic head of the present invention;

FIG. 13 is a sectional view of the shunt structure of the present invention;

FIG. 14 is a perspective view of a head slider including the magnetic head;

FIG. 15 is a plan view of a magnetic disk apparatus;

FIG. 16 is a sectional view of the conventional magnetic head; and

FIG. 17 is a plan view of the conventional magnetic head.

### DETAILED DESCRIPTION OF THE EMBODIMENTS

Preferred embodiments of the present invention will now be described in detail with reference to the accompanying drawings.

### (Structure of Magnetic Head)

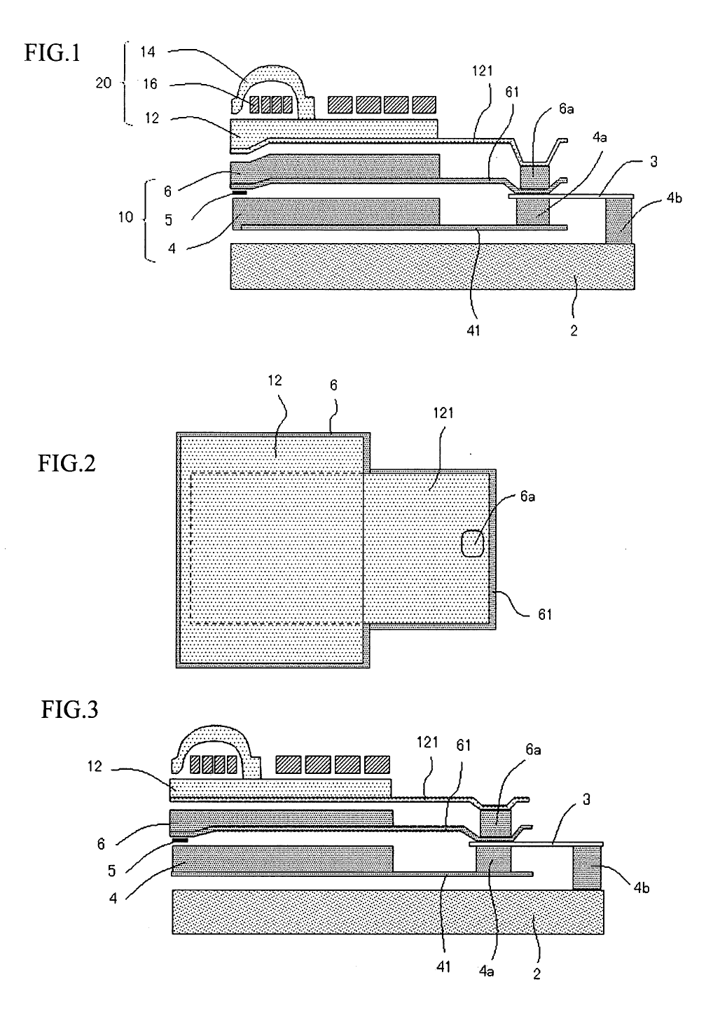

FIG. 1 is a sectional view of a magnetic head of a first embodiment of the present invention, and FIG. 2 is a plan view thereof. The magnetic head of the first embodiment is a GMR (Giant Magneto Resistance) type magnetic head, and its basic structure is the same as that of the magnetic head shown in FIG. 16. Namely, the magnetic head comprises: a read-head 10 having a lower shielding layer 4, an MR element 5 and an upper shielding layer 6, which are laminated on a substrate 2 made of ALTIC (Al₂O₃—TiC) with insulating layers; and a write-head 20 having a lower magnetic pole 12, an upper magnetic pole 14, a write-gap formed between the magnetic poles 12 and 14, and an exciting coil 16.

The lower shielding layer 4 and the upper shielding layer 6 of the read-head 10 are electrically connected to the substrate 2 via a shunt resistance 3 so as to prevent the MR element 5 from being damaged by static electricity, and the lower magnetic pole 12 of the write-head 20 is electrically connected to the substrate 2 via the shunt resistance 3, as well as the magnetic head shown in FIG. 16.

The lower shielding layer 4 is connected to one end of the shunt resistance 3 via a plating seed layer 41, which is a conductive layer and acts as a base layer of the lower shielding layer 4, and a conductive section 4a; the upper shielding layer 6 is connected to the one end of the shunt resistance 3 via a plating seed layer 61. The other end of the shunt resistance 3 is connected to an upper face of a substrate conductive section 4b, which is formed on the substrate 2, so that the shunt resistance 3 is electrically connected to the substrate 2 via the substrate conductive section 4b.

The magnetic head of the present embodiment is characterized by the write head 20 having the lower magnetic pole 12 connected to the shunt resistance 3. In the conventional magnetic head, the projection 12a is formed in the lower magnetic head 12, and the projection 12a is connected to the upper shielding layer 6 so as to connect the lower magnetic pole 12 to the upper shielding layer 6. On the other hand, in the present embodiment, the lower magnetic pole 12 is separated from the upper shielding layer 6 and connected to the shunt resistance 3 by using a plating seed layer 121, which is used to form the lower magnetic pole 12 by plating.

The plating seed layer 121 is extended heightwise or away from an air bearing surface, and an extended end of the plating seed layer 121 is connected to an upper conductive section 6a, which is formed on the conductive section 4a like a column, so that the plating seed layer 121 can be electrically connected to the shunt resistance 3.

As shown in FIG. 2, the lower magnetic pole 12 has a rectangular planar shape, and planar shapes of the upper shielding layer 6 and the lower shielding layer 4 are the same as that of the lower magnetic pole 12.

The plating seed layer 121, which is used to form the lower magnetic pole 12, is extended away from the air bearing surface, and the extended end the plating seed layer 121 is connected to the upper conductive section 6a.

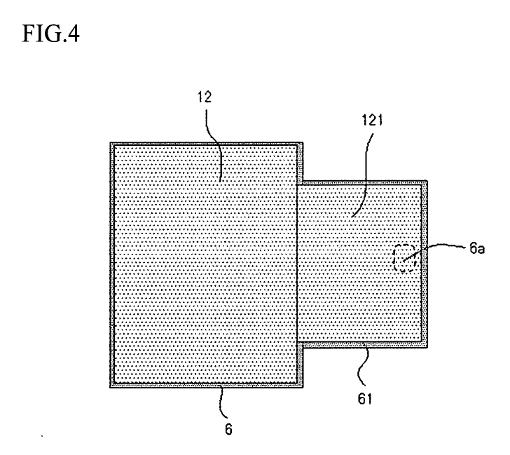

FIG. 3 is a sectional view of a magnetic head of a second embodiment of the present invention, and FIG. 4 is a plan view thereof. In the second embodiment too, the lower magnetic head 12 of the write-head 20 is separated from the upper shielding layer 6 of the read-head 10 and electrically connected to the shunt resistance 3 via the plating seed layer 121, which is used to form the lower magnetic pole 12, and the upper conductive section 6a, which is formed when the upper shielding layer 6 is formed, as well as the first embodiment.

The magnetic head shown in FIG. 3 is characterized in that the upper face of the upper shielding layer 6 and the upper face of the upper conductive section 6a are made flat when the lower magnetic pole 12 of the write-head 20 is formed; that the both flat upper faces thereof are included in the same plane; and that the lower magnetic pole 12 is electrically connected to the upper conductive section 6a via the plating seed layer 121.

By flattening the surface of the upper shielding layer 6, the plating seed layer 121 of the lower magnetic pole 12 does not interfere with the upper shielding layer 6 in the thickness direction, so that mutual interference (cross talk) between the lower magnetic pole 12 and the read-head 10 can be prevented. Therefore, the read-head 10 and the write-head 20 can be completely separated.

In the first and the second embodiments, the lower magnetic pole 12 of the write-head 20 is separated from the plating seed layer 121 by an insulating layer and electrically connected to the shunt resistance 3 via the plating seed layer 121 and the upper conductive section 6a. With this structure, the action of the write-head 20 does not badly influence characteristics of the read-head 10, so that the characteristics of the read-head 10 can be stably maintained. Further, electrostatic charge of the lower magnetic pole 12 of the write-head 20 can be prevented, so that resistance of the MR element 5 to static electricity can be improved.

In the above described embodiments, the CIP type magnetic heads have been explained. The structures of the above described embodiments may be applied to TMR type magnetic heads. In the TMR type magnetic head, the lower shielding layer 4 and the upper shielding layer 6 act as electrodes of the read-head, so a shunt resistance, which will be connected to the lower shielding layer 4, and another shunt resistance, which will be connected to the upper shielding layer 6, are separately formed in a plane, in which the shunt resistance 3 is formed. Then, the lower shielding layer 4 and the upper shielding layer 6 are connected to the substrate 2 via the shunt resistances respectively. Further, the lower magnetic pole 12 of the write-head 12 may be electrically connected to the substrate 2, via the plating seed layer 121, without using the shunt resistance 3.

### (Method of Producing Magnetic Head)

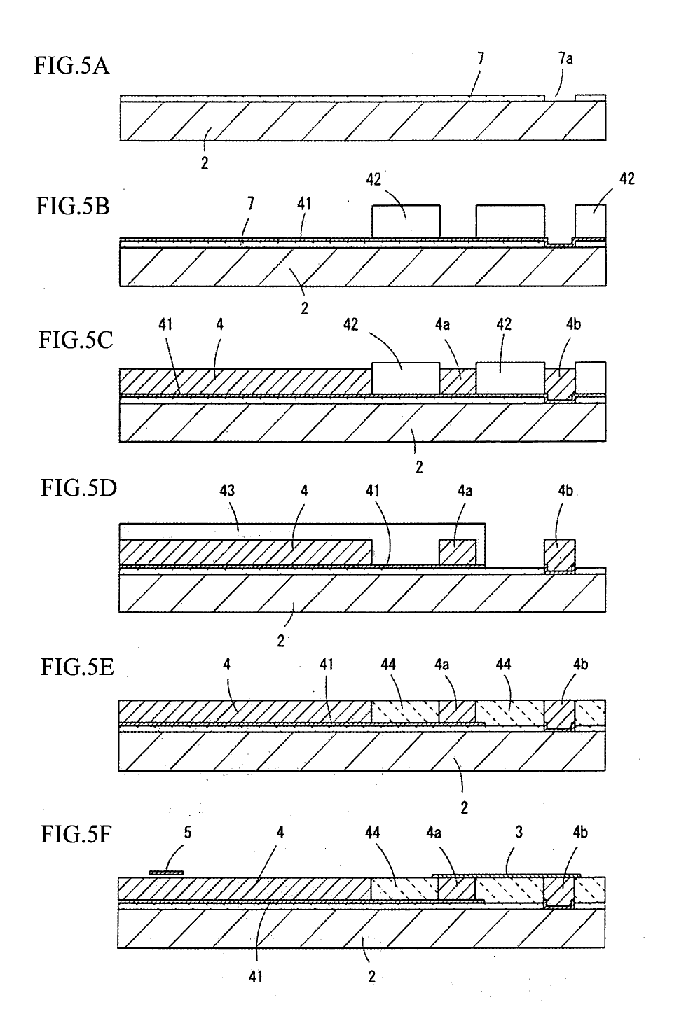

FIGS. 5A-7E show a production process of the magnetic head of the first embodiment. In FIGS. 5A-5F, the lower shielding layer 4 of the read-head 10, the conductive section 4a, the substrate conductive section 4b and the shunt resistance 3 are formed.

In FIG. 5A, an insulating layer 7 is formed on the entire surface of the substrate 2 by sputtering alumina, and

a conductive hole 7a is formed at a position corresponding to the conductive section 4a. The conductive hole 7a is formed by the steps of: coating the surface of the insulating layer 7 with resist 42; pattering the resist 42 so as to expose a part of the insulating layer 7, in which the conductive hole 7a will be formed; and performing ion milling with using the resist 42 as a mask.

In FIGS. 5B and 5C, the lower shielding layer 4, the conductive section 4a and the substrate conductive section 4b are formed by plating. In FIG. 5B, a plating seed layer 41 is formed on a surface of a work, the surface of the plating seed layer 41 is coated with the resist 42, and the resist 42 is patterned so as to expose parts of the plating seed layer 41, in which the lower shielding layer 4, the conductive section 4a and the substrate conductive section 4b will be formed.

In FIG. 5C, the lower shielding layer 4, the conductive section 4a and the substrate conductive section 4b are formed by electrolytic plating, in which the plating seed layer 41 is used as a power feed layer. The lower shielding layer 4 is made of a soft magnetic material, e.g., Ni, Fe. Therefore, the conductive section 4a and the substrate conductive section 4b are also made of the same soft magnetic material (conductive material) of the lower shielding layer 4.

In FIG. 5D, useless parts of the plating seed layer 41 are removed by ion milling. Resist 43 is patterned so as to coat parts of the surface of the work, in which the plating seed layer 41 will be left, and ion milling is performed with using the resist 43 as a mask so as to remove parts of the plating seed layer 41 exposed on the substrate 2. The resist 43 is patterned so as to connect the lower shielding layer 4 to the conductive section 4a via the plating seed layer 41.

In FIG. 5E, the entire surface of the work is coated by sputtering an insulating material, e.g., alumina, so as to coat the surfaces of the lower shielding layer 4, the conductive section 4a and the substrate conductive section 4b. Then, the surface of the work is chemical-mechanical-polished so as to flatten the surfaces of the lower shielding layer 4, the conductive section 4a, the substrate conductive section 4b and an insulating layer 44.

In FIG. 5F, the MR element 5 is formed on the lower shielding layer 4, whose surface has been flattened. The MR element 5 is formed by the steps of: forming an insulating layer on the surface of the work; laminating magneto resistance effect films, which constitute the MR element 5; and ion-milling the laminated films so as to form the laminated films into a prescribed shape of the MR element 5. The shunt resistance 3 and the MR element 5 are formed by separate steps. The shunt resistance 3, which is a thin conductive film, is formed, by patterning the conductive film into a zigzag shape, between the conductive section 4a and the substrate conductive section 4b.

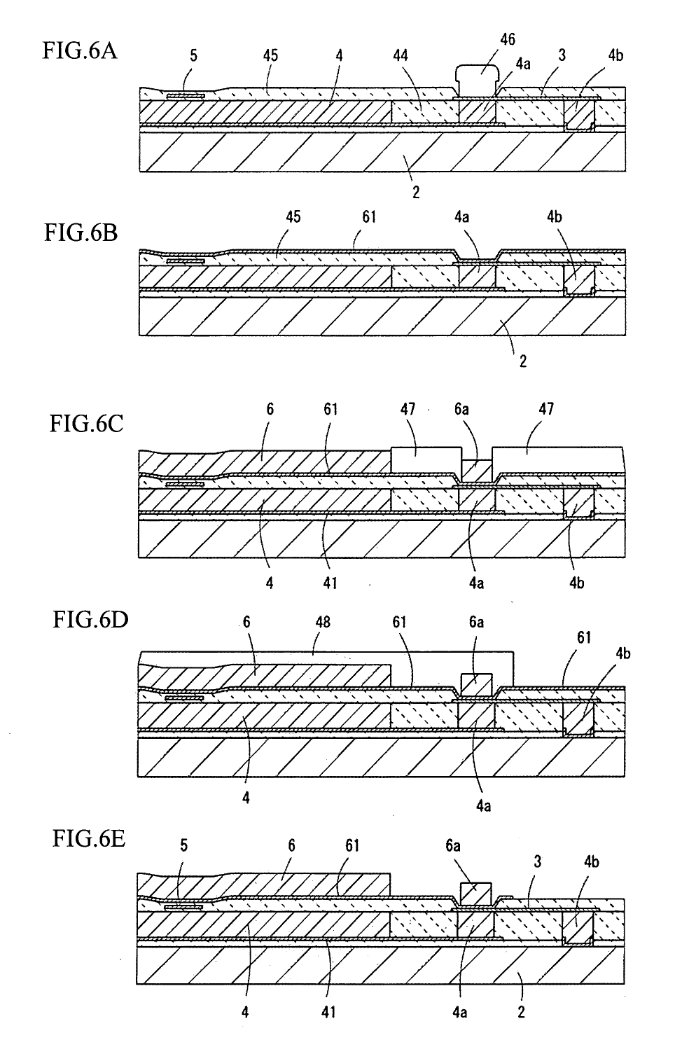

In FIGS. 6A-6E, a plating seed layer 61, which is connected to the upper shielding layer 6 and the shunt resistance 3, is formed.

In FIG. 6A, the MR element 5 and the shunt resistance 3 are coated with an insulating layer 45. The surface of the conductive section 4a is coated with resist 46, and then the insulating layer 45 is formed on the surface of the work by sputtering an insulating material, e.g., alumina.

In FIG. 6B, the plating seed layer 61 for forming the upper shielding layer 6 is formed on the surface of the insulating layer 45. After removing the resist 46, the plating seed layer 61 is formed on the entire surface of the work by sputtering. Since the surface of the conductive section 4a is exposed, the plating seed layer 61 can be connected to the conductive section 4a.

In FIG. 6C, the upper shielding layer 6 and the upper conductive section 6a are formed by electrolytic plating, in which the plating seed layer 61 is used as a power feeding layer. Resist 47 is patterned so as to expose parts of the plating seed layer 61, in which the upper shielding layer 6 and the upper conductive section 6a will be formed, and then the upper shielding layer 6 and the upper conductive section 6a are formed therein by plating.

In FIG. 6D, parts of the plating seed layer 61, which will be left, are coated with resist 48 after removing the resist 47. The resist 48 is patterned to cover the plating seed layer 61 so as to connect the upper shielding layer 6 to the upper conductive section 6a.

In FIG. 6E, ion milling is performed, with using the resist 48 as a mask, so as to remove useless parts of the plating seed layer 61, and then the resist 48 is removed.

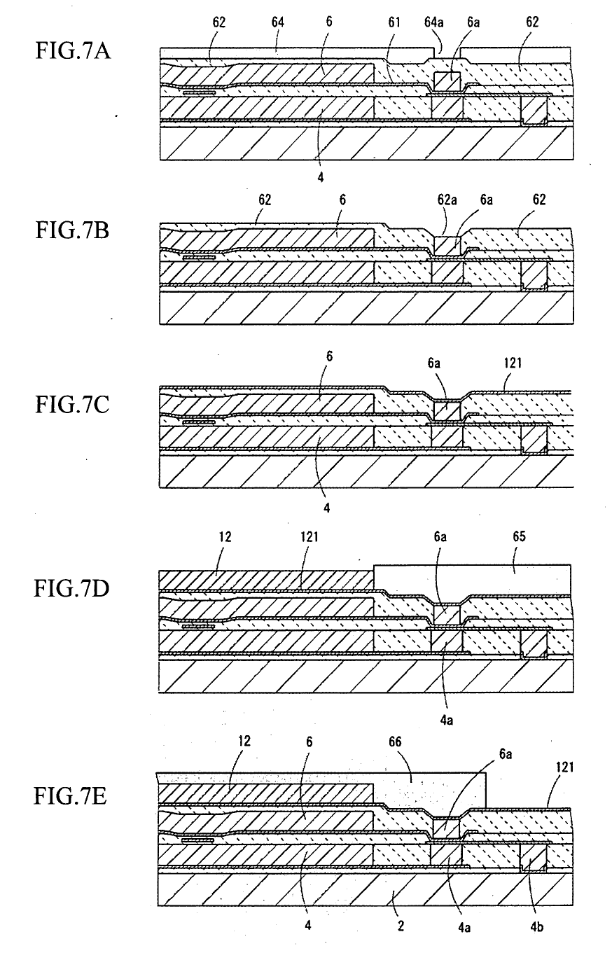

FIGS. 7A-7E show a process for forming a plating seed layer 121 and the lower magnetic pole 12 of the write-head 20.

In FIG. 7A, an insulating layer 62, which electrically insulates the upper shielding layer 6 from the lower magnetic pole 12 of the write-head 20, is formed. The surface of the work is coated with an insulating material, e.g., alumina, by sputtering, so as to form the insulating layer 62. Asperities of the upper shielding layer 6 and the upper conductive section 6a appear in the surface of the work as a slightly-uneven surface.

In FIG. 7A, the surface of the work is coated with the insulating layer 62, and then the surface of the work is coated with resist 64. Further, the resist 64 is patterned to form an opening part 64a, which corresponds to the upper conductive section 6a.

In FIG. 7B, ion milling is performed, with using the resist 64 as a mask, so as to form a hole 62a of the insulating layer 62, in which the upper face of the upper conductive section 6a is exposed.

In FIG. 7C, the plating seed layer 121 of the lower magnetic pole 12 is formed on the surface of the work. The plating seed layer 121 coats the surface of the insulating layer 62, the surface of the upper conductive section 6a, which is exposed in the hole 62a, and an inner circumferential face of the hole 62. With this structure, the plating seed layer 121 can be electrically connected to the upper conductive section 6a.

In FIG. 7D, the lower magnetic pole 12 of the write-head 20 is formed by electrolytic plating, in which the plating seed layer 121 is used as a power feed layer. The surface of the plating seed layer 121 is coated with resist 65, and the resist 65 is patterned so as to expose a part of the plating seed layer 121, in which the lower magnetic pole 12 will be formed. The lower magnetic pole 12 is formed on the plating seed layer 121 by plating.

In FIG. 7E, the surface of the work is coated with resist 66, and the resist 66 is patterned so as to expose useless parts of the plating seed layer 121. The useless parts of the plating seed layer 121 are removed by ion milling. Note that, the resist 66 is patterned so as to coat parts of the plating seed layer 121, which is used to connect the lower magnetic pole 12 to the upper conductive section 6a.

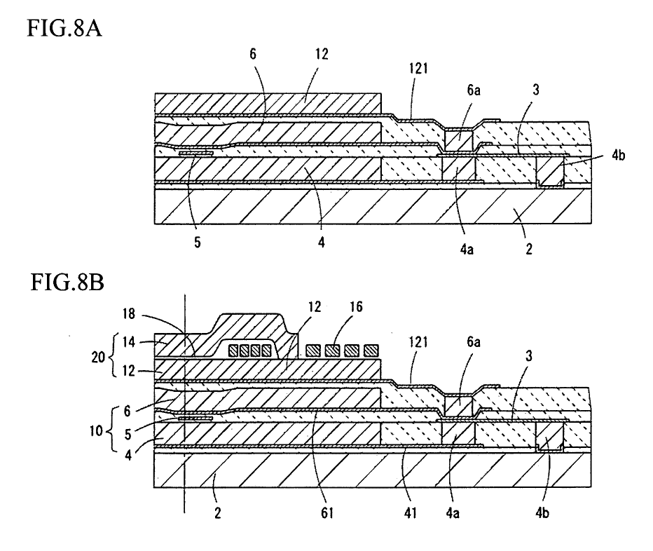

In FIG. 8A, ion milling is performed, with using the resist 66 as a mask, so as to remove useless parts of the plating seed layer 121, which are exposed in the surface of the work.

After forming the lower magnetic pole 12, the upper magnetic pole 14 and the coil 16 are formed. Note that, a write-gap 18 is formed between the magnetic poles 12 and 14.

FIG. 18B shows the completed magnetic head having the read-head 10 and the write-head 20.

In the above described method, the upper conductive section 6a is formed while the upper shielding layer 6 is formed, the insulating layer 62 is ion-milled so as to form the hole 62a, which is communicated to the upper conductive section 6a, and the plating seed layer 121 is electrically connected to the upper conductive section 6a. The above described method can be performed by slightly changing a conventional production method, and characteristics of the magnetic head can be improved by using the conventional production method.

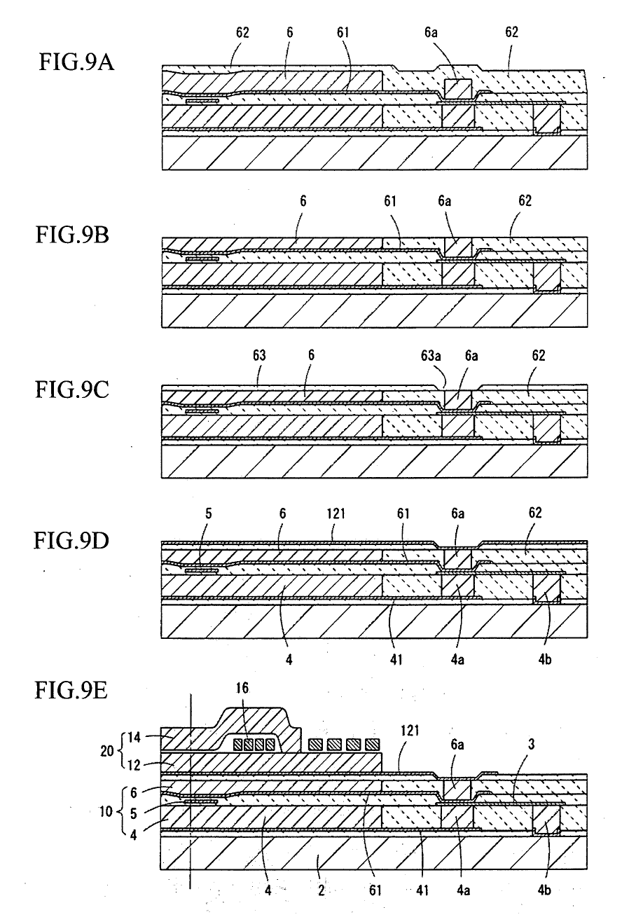

FIGS. 9A-9E show a method of producing the magnetic head of the second embodiment shown in FIG. 3. In the present method, the upper shielding layer 6 and the upper conductive section 6a are formed, the surface of the work is coated with the insulating layer 62, and then the surface of the work is chemical-mechanical-polished so as to include the upper face of the upper shielding layer 6 and the upper face of the conductive upper section 6a in the same plane.

In FIG. 9A, the surface of the work is coated with the resist 62.

In FIG. 9B, the surface of the work is chemical-mechanical-polished, so that the upper face of the upper shielding layer 6 and the upper face of the conductive upper section 6a are included in the same plane.

In FIG. 9C, an insulating layer 63, which insulates the upper shielding layer 6 from the lower magnetic pole 12 of the write-head 20, is formed, and a hole 63a for exposing an end face of the upper conductive section 6a is formed in the insulating layer 63. A part, in which the hole 63a will be formed, is coated with resist, and then the insulating layer 63 is formed by sputtering an insulating material, e.g., alumina.

In FIG. 9D, the plating seed layer 121 of the lower magnetic pole 12 is formed on the surface of the work. The plating seed layer 121 coats the surface of the insulating layer 63, the surface of the upper conductive section 6a and the inner circumferential face of the hole 63a. Therefore, the plating seed layer 121 is electrically connected to the upper conductive section 6a.

After forming the plating seed layer 121, the lower magnetic pole 12 is formed by electrolytic plating, in which the plating seed layer 121 is used as a power feed layer. Further, useless parts of the plating seed layer 121 are removed.

In FIG. 9E, the upper magnetic pole 14 and the coil 16 of the write-head 20 are formed. With this step, the magnetic head shown in FIG. 3 is completed.

In the above described method, the lower shielding layer 4, the upper shielding layer 6 and the lower magnetic pole 12 are formed by electrolytic plating. The plating seed layers 41, 61 and 121, which are used for electrolytic plating, are used to electrically connect the lower shielding layer 4, the upper shielding layer 6 and the lower magnetic pole 12 to the substrate 2. Conductive layers, whose patterns are the same as those of the plating seed layers, may be used, instead of the plating seed layers, so as to electrically connect the lower shielding layer 4, the upper shielding layer 6 and the lower magnetic pole 12 to the substrate 2.

### (Shunt Structure of Lower Magnetic Pole)

In each of the above described embodiments, the lower shielding layer 4, the upper shielding layer 6 and the lower magnetic pole 12 are electrically connected to the substrate 2 via the conductive layers, so that resistance of the magnetic head to static electricity can be effectively improved.

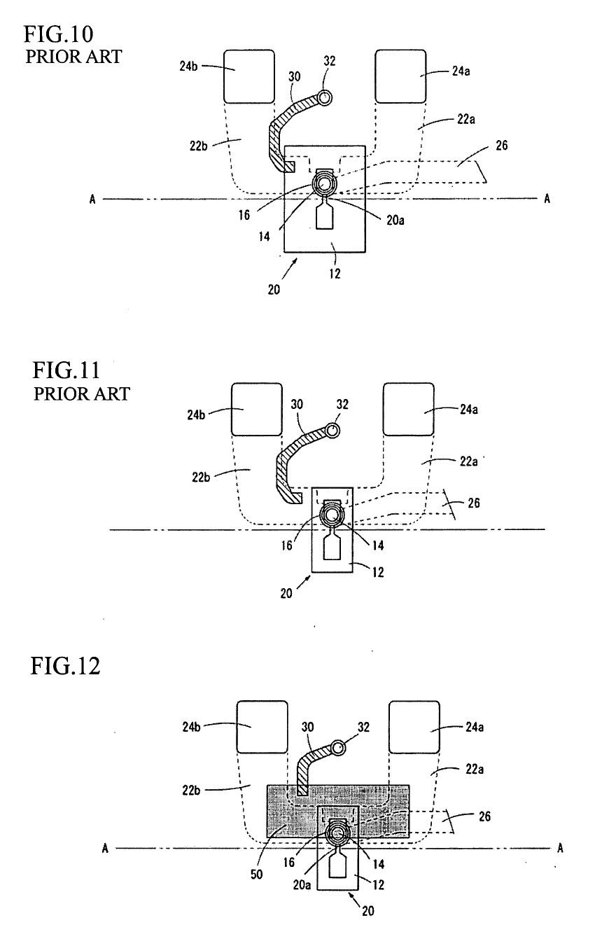

FIG. 10 is a plan view of the magnetic head. The shown magnetic head is not completed. The air bearing surface will be formed along a line A-A. The lower magnetic pole 12 has a rectangular planar shape, and the upper shielding layer 6 and the lower shielding layer 4, whose planar shapes are the same as that of the lower magnetic pole 12, are formed under the lower magnetic pole 12.

Wires 22a and 22b are connected to the lower shielding layer 4 and the upper shielding layer 6 of the read-head 10. Further, the wires 22a and 22b are connected to read-electrodes 24a and 24b. Note that, wires are connected to the coil 16 of the write-head 20, and they are further connected to write-electrodes. In FIG. 10, one of wires 26 of the write-head 20 is shown.

Patterns of the wires connected to the write-head 20 and the read-head 10 are optionally designed.

A conventional shunt structure of the write-head 20 of the CPP type magnetic head is shown in FIG. 10. As shown in FIG. 10, a shunt wire 30 is extended from the upper face of the lower magnetic pole 12, and the wire 30 is connected to a conductive section 32, which electrically connects the wire 30 to the substrate 2. Concretely, the coil 16 and the shunt wire 30 are simultaneously patterned, and then the shunt wire 30 is connected to the conductive section 32.

However, in the latest magnetic head, read-characteristics must be stable, short circuit of elements must be prevented when a head slider is processed, and the lower magnetic pole 12, the lower shielding layer 4 and the upper shielding layer 6 must be downsized so as to downsize the magnetic poles and prevent the magnetic head from damages caused by colliding the magnetic head with a recording medium.

FIG. 11 shows another conventional magnetic head having the lower magnetic pole 12, the lower shielding layer 4 and the upper shielding layer 6, which are downsized. By employing the downsized lower magnetic pole 12, a connecting point of the shunt wire 30 and the lower magnetic pole 12 is located close to a core section of the write-head 20, so the connecting point and the coil 16 of the write-head 20 are overlapped and mutually interfere. Therefore, it is difficult to form the shunt wire 30.

FIG. 12 shows the magnetic head having the shunt structure of the present invention. A conductive layer 50 is formed under the lower magnetic pole 12 and connected thereto. Further, the conductive layer 50 is outwardly extended from the lower magnetic pole 12. The shunt wire 30 is connected to the conductive layer 50. Since the conductive layer 50 is outwardly extended from the lower magnetic pole 12, the shunt wire 30 can be formed and connected without interfering with the write-head 20.

In FIG. 12, the conductive layer 50 has a rectangular planar shape, but the planar shape may be optionally designed.

The wire 26 of the write-head 20 and the wire 22a of the read-head are usually crossed near a core section 20a. Thus, the position and the shape of the conductive layer 50 are designed to shield a particular part, in which the wires of the write-head 20 and the read-head are crossed, so that electric interference between the write-head 20 and the read-head can be prevented.

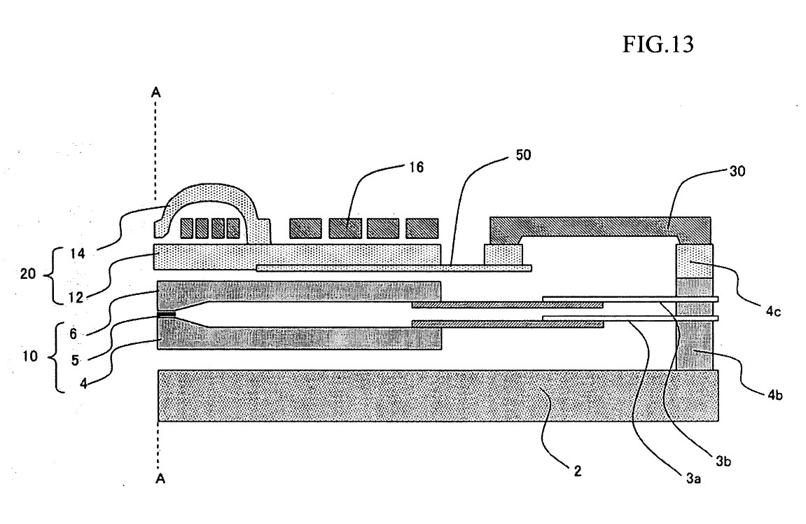

FIG. 13 is a sectional view of the magnetic head, in which the conductive layer 50 is formed on the lower magnetic pole 12 of the write-head 20. The conductive layer 50 is extended upward (rightward in the drawing) from an upper edge of the lower magnetic pole 12. The shunt wire 30 is connected to the conductive layer 50 and a conductive section 4c. Resistance value of the conductive layer 50 and the shunt wire 30 is several Ω. Since the lower magnetic pole 12 need not be connected to electrodes, the lower magnetic pole 12 needs no shunt resistance. In other words, the conductive layer 50 and the wire 30 act as shunt resistances. Note that, the lower shielding layer 4 and the upper shielding layer 6 are connected to the substrate 2 via shunt resistances 3a and 3b.

The conductive layer 50 is formed by the steps of: forming the upper shielding layer 6; coating the surface of the work with an insulating material; flattening the surface of the work; and patterning the conductive layer 50 by sputtering. The shunt wire 30 is formed by the steps of: forming the lower magnetic pole 12; coating the surface of the work with an insulating material; flattening the surface of the work; and connecting to the conductive layer 50 while patterning the coil 16.

In FIG. 13, a core section side end of the conductive layer 50 is slightly shifted upward from the air bearing surface, which is indicated by a line A-A, but the conductive layer 50 may be extended until reaching the air bearing surface. The material of the conductive layer 50 is not limited, but materials having superior resistance to corrosion, e.g., Ta, Ru, are used as suitable materials. In the above described embodiment, the wire 30 is formed while the coil 16 is formed, and the lower magnetic pole 12 is connected to the substrate 2 via the conductive layer 50. In another case, the wire, which connects the conductive layer 50 to the conductive section 32, and the conductive layer 50 may be simultaneously formed.

### (Head Slider)

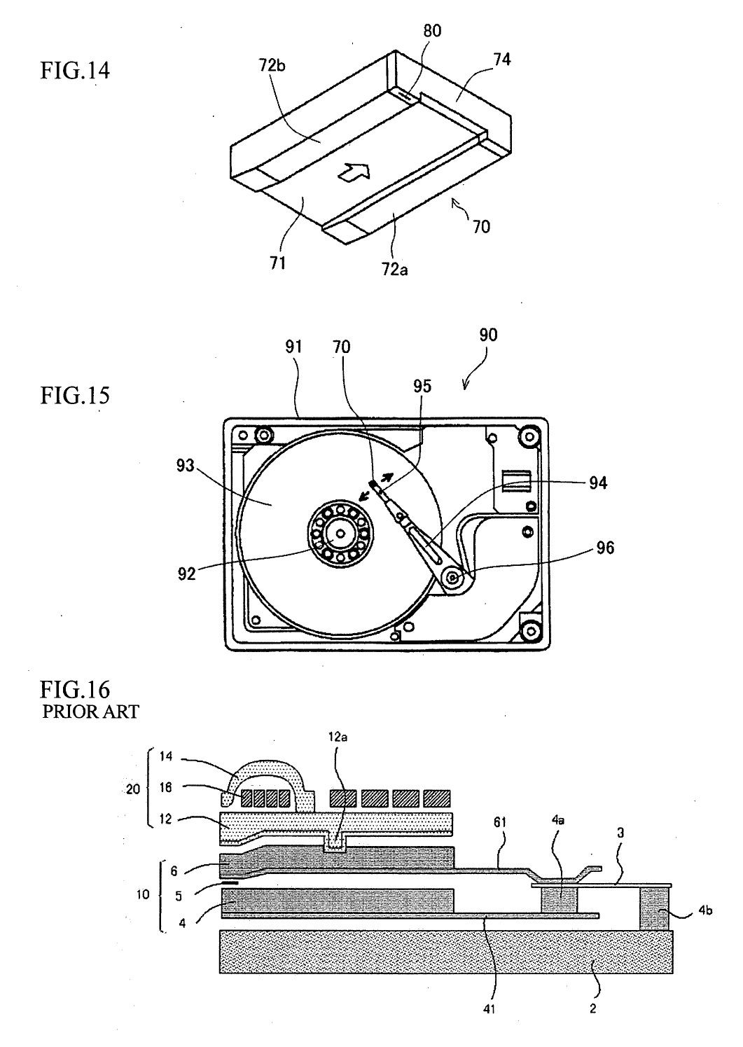

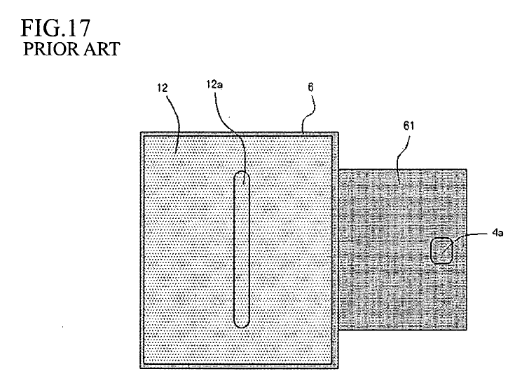

The above described magnetic heads having the shunt structures are formed in head sliders formed in a wafer. The wafer is cut to separate the head sliders respectively. The separated head slider 70 is shown in FIG. 14. Floating rails 72a and 72b, which float the head slider 70 from a surface of a magnetic disk, are formed in a disk side face of the head slider 70 and extended along side edges of a slider main body 71. A magnetic head 80, which includes the above described read-head and write-head, is provided to a front end side (air-downstream side) of the head slider 70 so as to face the magnetic disk. The magnetic head 80 is protected by a protection film 74.

FIG. 15 shows a magnetic disk apparatus 90 including the head sliders 70. The magnetic disk apparatus 90 further includes: a casing 91 formed like a rectangular box; a spindle motor 92 provided in the casing 91; and a plurality of magnetic disks 93, which are rotated by the spindle motor 92. Carriage arms 94, which can be turned parallel to the surface of the magnetic disks 93, are provided near the magnetic disks 93. A head suspension 95 is attached to a front end of each of the carriage arms 94, and the head slider 70 is attached to a front end of each of the head suspensions 95. Each of the head sliders 70 is attached in a disk side face of each of the head suspensions 95.

The head sliders 70 are elastically biased toward the surface of the magnetic disks 93 by the head suspensions 95. When the rotation of the magnetic disks 93 is stopped, the head sliders 70 respectively contact the surfaces of the magnetic disks 93. This structure is called “contact start”. When the magnetic disks 93 are rotated by the spindle motor 92, the rotating disks 93 generate air streams, so that the head sliders 70 are floated from the surfaces of the magnetic disks 93. A control section controls an actuator 96 so as to turns the carriage arms 94, so that the magnetic heads 80 attached to the head sliders 70 are moved to object positions and capable of writing data on and reading data from the magnetic disks 93.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic head, comprising:
a read-head having a lower shielding layer and an upper shielding layer, which are electrically connected to a substrate via a shunt resistance; and
a write-head having a lower magnetic pole, which is electrically connected to the substrate via the shunt resistance,
wherein the lower shielding layer and the upper shielding layer are electrically connected to the substrate via a conductive layer, and
the lower magnetic pole is electrically connected to the substrate via a conductive layer, which is formed as a base layer of the lower magnetic pole.

2. The magnetic head according to claim 1,
wherein a plating seed layer of the lower magnetic pole is used as the conductive layer of the lower magnetic pole.

3. The magnetic head according to claim 2,
wherein the lower shielding layer is connected to the shunt resistance via a conductive section, and
the lower magnetic pole is connected to the shunt resistance via an upper conductive section.

4. The magnetic head according to claim 3,
wherein an upper face of the upper shielding layer and an upper face of the upper conductive section are included in the same plane.

5. The magnetic head according to claim 1,
wherein the conductive layer of the lower magnetic pole is extended beyond an outer edge of the lower magnetic pole, and
the lower magnetic pole is electrically connected to the substrate via said conductive layer.

6. The magnetic head according to claim 5,
wherein a planar shape of said conductive layer is designed to shield a wire area, in which a wire connected to the read-head are provided, from another wire area, which overlaps the wire area and in which a wire connected to the write-head is provided.

7. A method of producing a magnetic head,
comprising:
a step of forming a lower shielding layer, a conductive section, to which one end of a shunt resistance will be connected, and a substrate conductive section, to which the other end of the shunt resistance will be connected, on a substrate by electrolytic plating, in which a plating seed layer is used as a power feed layer;
a step of forming an MR element and the shunt resistance, which are connected to the conductive section and the substrate conductive section, in a layer above the lower shielding layer;
a step of forming a plating seed layer on the layer including the MR element and the shunt resistance, forming an upper shielding layer, which is connected to the conductive section, by electrolytic plating, in which the plating seed layer is used as a power feed layer, and forming an upper conductive section connected to the conductive section; and
a step of forming a plating seed layer, which is connected to the upper conductive section, on the upper shielding layer, and a lower magnetic pole by electrolytic plating, in which the plating seed layer is used as a power feed layer.

8. A head slider, comprising:
a magnetic head including a write-head and a read-head,
wherein the read-head has a lower shielding layer and an upper shielding layer, which are electrically connected to a substrate via a shunt resistance,
the write-head has a lower magnetic pole, which is electrically connected to the substrate via the shunt resistance,
the lower shielding layer and the upper shielding layer are electrically connected to the substrate via a conductive layer, and
the lower magnetic pole is electrically connected to the substrate via a conductive layer, which is formed as a base layer of the lower magnetic pole.

9. The head slider according to claim 8,
wherein a plating seed layer of the lower magnetic pole is used as the conductive layer of the lower magnetic pole.

10. A magnetic disk apparatus, comprising:
a head slider including a magnetic head, which writes data on and reads data from a magnetic recording medium by a write-head and a read-head,
wherein the read-head has a lower shielding layer and an upper shielding layer, which are electrically connected to a substrate via a shunt resistance, the write-head has a lower magnetic pole, which is electrically connected to the substrate via the shunt resistance,
the lower shielding layer and the upper shielding layer are electrically connected to the substrate via a conductive layer, and
the lower magnetic pole is electrically connected to the substrate via a conductive layer, which is formed as a base layer of the lower magnetic pole.
